(19) United States
(12) Patent Application Publication
(10) Pub. No.: US 2021/0073906 A1
(43) Pub. Date: Mar. 11, 2021

(54) SYSTEM AND APPLICATION TO FACILITATE AND TRACK MONETARY TRANSACTIONS

(71) Applicant: Aaron Bailey, San Francisco, CA (US)

(72) Inventor: Aaron Bailey, San Francisco, CA (US)

(21) Appl. No.: 16/561,807

(22) Filed: Sep. 5, 2019

(51) Int. Cl. G06Q 40/02; G06Q 50/18

(52) U.S. Cl. CPC G06Q 40/025; G06Q 50/182; G06Q 50/188

(57) ABSTRACT

A system having a program running thereon to facilitate and track monetary transactions, the system including a storage device to store data regarding monetary transactions, at least one first apparatus, including a display unit to display to at least one borrower a listing of potential lenders, and an input unit to allow the at least one borrower to request a loan from at least one of the potential lenders, and to link a bank account of the at least one borrower, and at least one second apparatus, including another display unit to display to at least one lender a listing of potential borrowers, and another input unit to allow the at least one lender to input an interest rate, a repayment term, acceptance of the request of the loan, and a bank account of the at least one lender.

### BACKGROUND

### 1. Field

The present general inventive concept relates generally to an application to track monetary transactions, and particularly, to a system and application to facilitate and track monetary transactions.

### 2. Description of the Related Art

Lending and borrowing money is a common practice among many people for different reasons. A borrower may seek a lender for a wide variety of reasons. For example, the borrower may not have enough money to purchase an item or pay for costs related to higher education. Alternatively, the borrower may seek to reduce long-term liability or prolong the value of money by making payments over time, rather than making a lump sum payment.

On the other hand, the lender may seek to lend money for different reasons with respect to the at least one borrower. For example, the lender may be seeking to reduce tax liability or earn interest on money.

Currently, Lenmo Inc has created a Lenmo application. Lenmo connects people looking to borrow and other people looking to make money. Lenmo is integrated with social media platforms to connect users with friends and family. Additionally, Lenmo allows the borrower to choose a term of repayment. Conversely, lenders can choose an amount of interest and lend money based on a risk score associated with the borrower.

However, Lenmo does not include features such as payment reminders using a calendar, multiple borrowers, multiple lenders, modifiable interest rates, and/or legal enforcement.

Therefore, there is a need for an application that facilitates lending money that allows multiple parties to participate, as well as, providing legal enforcement of repayment terms.

### SUMMARY

The present general inventive concept provides a system and application to facilitate and track monetary transactions.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system having a program running thereon to facilitate and track monetary transactions, the system including a storage device to store data regarding monetary transactions, at least one first apparatus, including a display unit to display to at least one borrower a listing of potential lenders, and an input unit to allow the at least one borrower to request a loan from at least one of the potential lenders, and to link a bank account of the at least one borrower, and at least one second apparatus, including another display unit to display to at least one lender a listing of potential borrowers, and another input unit to allow the at least one lender to input an interest rate, a repayment term, acceptance of the request of the loan, and a bank account of the at least one lender.

The system may further include a network to allow communication between the storage device, the at least one first apparatus, and the at least one second apparatus.

The data regarding the monetary transactions may include at least one of registration profiles, contacts, files, requests, request acceptances, interest rates, schedules, repayment terms, legal agreements, calendars, payment reminders, payments, programs, application data, and code.

The second apparatus may deduct money from the bank account of the at least one lender to deposit the money into the bank account of the at least one borrower in response to an agreement between the at least one borrower and the at least one lender of terms of the loan.

The at least one first apparatus may deduct money from the bank account of the at least one borrower in response to a due payment.

The at least one first apparatus may remind the at least one borrower in response to a predetermined time period of a due payment.

The at least one second apparatus may take action in response to a missed payment by the at least one borrower.

The action by the at least one second apparatus may adjust the interest rate.

The action by the at least one second apparatus may notify at least one of police, a court, and an arbitrator.

The action by the at least one second apparatus may be automatic garnishment of money from the bank of the at least one borrower until the loan is repaid.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a system to facilitate and track monetary transactions, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Storage Device 110
First Apparatus 120
Input Unit 121
Display Unit 122
Processing Unit 123
Communications Unit 124
Storage Unit 125
Second Apparatus 130
Input Unit 131
Display Unit 132
Processing Unit 133
Communications Unit 134
Storage Unit 135
Network 140

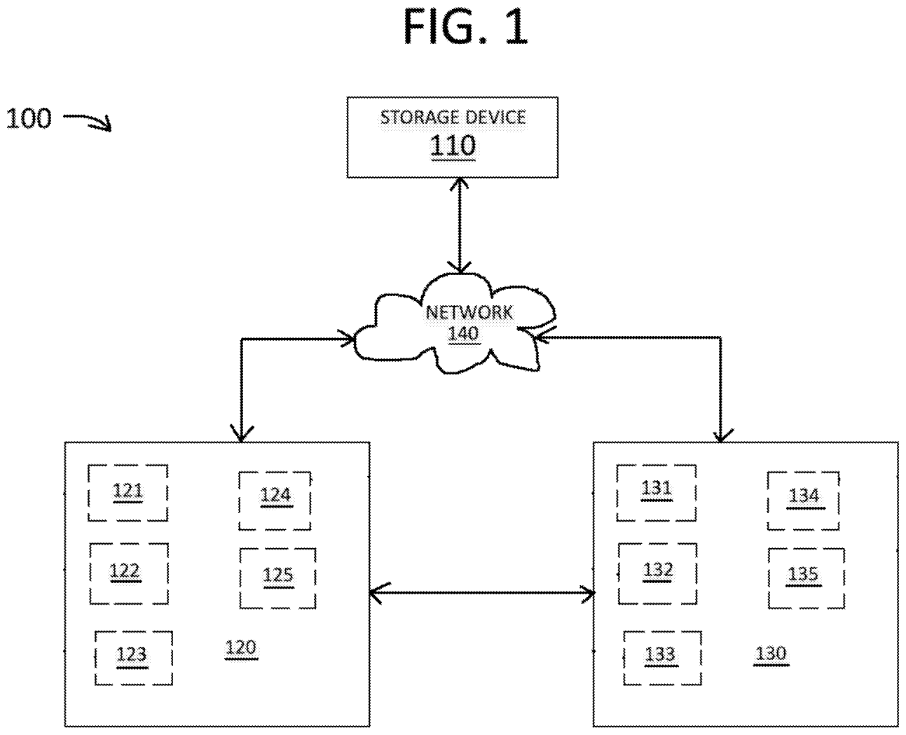

FIG. 1 illustrates a system to facilitate and track monetary transactions, according to an exemplary embodiment of the present general inventive concept.

The system 100 may include a storage device 110, at least one first apparatus 120, at least one second apparatus 130, and a network 140, but is not limited thereto.

Herein, at least one borrower may use the at least one first apparatus 120 to find at least one lender using the at least one second apparatus 130, via a mobile and/or a software application. Conversely, the at least one lender may use the at least one second apparatus 130 to find the at least one borrower using the at least one first apparatus 120, via the mobile and/or the software application.

The storage device 110 may include a server, a computing device with a storage unit, and a cloud-based storage space, but is not limited thereto. The storage device 110 may store at least one of registration information of profiles of potential borrowers, lenders, contacts, files, requests, request acceptances, interest rates, schedules, repayment terms, legal agreements, calendars, payment reminders, payments, programs, application data, code, and any other information pertaining to borrowers and/or lenders of money.

The storage device 110 may also include an embedded background application that will be required by most or all borrowers and/or lenders to fill out and renew periodically, every predetermined number of years (e.g., 2 years). This background check may be visible to all users once they click on a profile of at least one other borrower and/or at least one other lender. Every borrower may have a profile where they will include information related to an amount of money requested, interest rate preferred, ratings from lenders, reviews from lenders, credit score, and/or credit history. Moreover, every lender may have a profile that includes information related to an amount of money lent, range of interest rates offered, ratings from borrowers, reviews from borrowers, and/or frequency of giving loans.

The at least one first apparatus 120 may include an input unit 121, a display unit 122, a processing unit 123, a communication unit 124, and a storage unit 125, but is not limited thereto.

The input unit 121 may include a keyboard, a touchpad, a mouse, a trackball, a stylus, a voice recognition unit, a visual data reader, a camera, a wireless device reader, and a holographic input unit.

The display unit 122 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 122 may be combined with the input unit 121 to be a touch-screen.

The processing unit 123 (or central processing unit, CPU) may include electronic circuitry to carry out instructions of a computer program by performing basic arithmetic, logical, control and input/output (I/O) operations specified by the instructions. The processing unit 123 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 123 may also include a microprocessor and a microcontroller.

The communication unit 124 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 125 may include a random access memory (RAM), a read-only memory (ROM), a hard disk, a flash drive, a database connected to the Internet, cloud-based storage, Internet-based storage, or any other type of storage unit.

The at least one first apparatus 120 may access the Internet via the communication unit 124 to allow the at least one borrower to access a website, and/or may allow the mobile and/or the software application to be executed using the processing unit 123. For ease of description, the mobile and/or the software application will be hereinafter referred to as an app. The app may be downloaded from the Internet to be stored on the storage unit 125.

The at least one first apparatus 120 may use the app to allow the at least one 0borrower to find lenders corresponding to criteria specified by the at least one borrower, such as a preferred interest rate, repayment term, legal agreements, etc. Also, the at least one first apparatus 120 may use the app to connect the at least one borrower to friends, family, social media acquaintances, and/or other users. Also, the at least one borrower may indicate a preference to communicate with friends and/or family to request a loan. In other words, the at least one borrower may select via the input unit 121 to communicate with specific people, such as friends and/or family. Nevertheless, the at least one first apparatus 120 via the app may present any potential lender to the at least one borrower, such that the at least one borrower may browse for the loan and/or loan terms preferred by the at least one borrower.

The at least one borrower may use the input unit 121 to indicate predetermined terms of the loan. Alternatively, the at least one borrower may use the input unit 121 to input data that is displayed on the display unit 122. The processing unit 123 may send a store command via the communication unit 124 to at least one of the storage unit 125, the storage device 110, and the at least one second apparatus 130. As such, the storage unit 125, the storage device 110, and/or the at least one second apparatus 130 may store the input data of the loan request from the at least one borrower, such that the input data of the loan request may be synchronized. Also, the at least one first apparatus 120 may request the at least one borrower to link a bank account of the at least one borrower to the profile of the at least one borrower.

The at least one borrower may specify a reason for the loan, such as starting a business and/or debt consolidation.

The at least one second apparatus 130 may include an input unit 131, a display unit 132, a processing unit 133, a communication unit 134, and a storage unit 135, but is not limited thereto.

The input unit 131 may include a keyboard, a touchpad, a mouse, a trackball, a stylus, a voice recognition unit, a visual data reader, a camera, a wireless device reader, and a holographic input unit.

The display unit 132 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 132 may be combined with the input unit 131 to be a touch-screen.

The processing unit 133 (or central processing unit, CPU) may include electronic circuitry to carry out instructions of a computer program by performing basic arithmetic, logical, control and input/output (I/O) operations specified by the instructions. The processing unit 133 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 133 may also include a microprocessor and a microcontroller.

The communication unit 134 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 135 may include a random access memory (RAM), a read-only memory (ROM), a hard disk, a flash drive, a database connected to the Internet, cloud-based storage, Internet-based storage, or any other type of storage unit.

The at least one second apparatus 130 may access the Internet via the communication unit 134 to allow the at least one lender to access the app, as described above, to be executed using the processing unit 133. The app may be downloaded from the Internet to be stored on the storage unit 135. The at least one second apparatus 130 may use the app to allow the at least one lender to find borrowers corresponding to criteria specified by the at least one lender, such as an amount of the loan, credit score, credit history, ratings from other lenders, reviews from other lenders, repayment term, legal agreements, etc. Also, the at least one second apparatus 120 may use the app to connect the at least one lender to friends, family, and other users. Also, the at least one lender may indicate a preference to communicate with friends and family to provide the loan.

The at least one lender may use the input unit 131 to indicate predetermined terms of the loan. Alternatively, the at least one lender may use the input unit 131 to input data that is displayed on the display unit 132. The processing unit 133 may send another store command via the communication unit 134 to at least one of the storage unit 135, the storage device 110, and the at least one first apparatus 120. As such, the storage unit 135, the storage device 110, and/or the at least one first apparatus 120 may store the input data of the loan request from the at least one borrower, such that the input data of the loan request may be synchronized. Specifically, the communication unit 134 of the at least one second apparatus 130 may receive the store command from the communication unit 124 of the at least one first apparatus 120 to store the predetermined terms of the loan of the at least one borrower. The communication unit 134 may transmit the store command to the processing unit 133, such that the processing unit 133 stores the data from the at least one first apparatus 120 on the storage unit 135 and/or the storage device 110.

Conversely, the communication unit 124 of the at least one first apparatus 120 may receive the another store command from the communication unit 134 of the at least one second apparatus 130 to store the predetermined terms of the at least one lender. The communication unit 124 may transmit the another store command to the processing unit 123, such that the processing unit 123 stores the data from the at least one second apparatus 130 on the storage unit 125 and/or the storage device 110.

Also, the at least one second apparatus 130 may request the at least one lender to link a bank account of the at least one lender to the profile of the at least one lender.

The at least one second apparatus 130 may receive all loan requests currently available, by using filter options on the app. In other words, the at least one lender may view on the display unit 132 the loan requests based on customized preferences. Similarly, the at least one first apparatus 120 may view all available lenders on the display unit 121, and/or restrict the available lenders based on customized preferences using the filter options.

The at least one second apparatus 130 may include a meeting request by the at least one lender. Specifically, the at least one lender may select the meeting request on the app, such that the at least one lender sends the meeting request using the communication unit 134 to the communication unit 124 of the at least one first apparatus that is received by the processing unit 123, such that the at least one borrower may be notified of the meeting request. The at least one lender may select to have a face-to-face meeting, a phone call, and/or a video call based on a distance away the at least one borrower is from the at least one lender. For example, the at least one lender may desire to meet the at least one borrower before disbursing the amount of money for the loan.

As such, the app stored on the at least one first apparatus 120 may include a global positioning system (GPS) map viewable on the display unit 121 that is always current and updated. Similarly, the app stored on the at least one second apparatus 130 may include the GPS map viewable on the display unit 131 that is always current and updated. The at least one borrower and/or the at least one lender may designate a meeting location if the at least one borrower and/or the at least one lender are close to each other, such that the at least one borrower and/or the at least one lender may choose to face-to-face. As such, the GPS may facilitate the at least one first apparatus 120 and/or the at least one second apparatus 130 displaying the meeting location, a location of the at least one borrower, and/or a location of the at least one lender.

The at least one lender may view the profile of the at least one borrower on the display unit 132 of the at least one second apparatus 130. Moreover, the at least one lender may communicate by sending a message via a messaging form on the display unit 132, and the at least one lender may hit SEND using the input unit 131. The communication unit 134 of the at least one second apparatus 130 may transmit the message to the communication unit 124 of the at least one first apparatus 120, such that the at least one borrower may receive an instant notification of the message on the display unit 122 of the at least one first apparatus 120 via the app running on the at least one first apparatus 120. Subsequently, the at least one borrower may use the input unit 121 of the at least one first apparatus 120 to respond.

Alternatively, the at least one lender may view the profile of the at least one borrower on the display unit 132 of the at least one second apparatus 130 and dial a phone number of the at least one borrower to initiate a phone call and/or a video call, and the at least one lender may hit CALL using the input unit 131. The communication unit 134 of the at least one second apparatus 130 may dial the phone number of the at least one borrower using the communication unit 124 of the at least one first apparatus 120, such that the at least one borrower may receive an incoming call notification on the display unit 122 of the at least one first apparatus 120 via the app running on the at least one first apparatus 120. Subsequently, the at least one borrower may use the input unit 121 of the at least one first apparatus 120 to respond.

Alternatively, the at least one borrower may view the profile of the at least one lender on the display unit 122 of the at least one first apparatus 120. Moreover, the at least one borrower may communicate by sending another message via the messaging form on the display unit 122, and the at least one borrower may hit SEND using the input unit 121. The communication unit 124 of the at least one first apparatus 120 may transmit the message to the communication unit 134 of the at least one second apparatus 130, such that the at least one lender may receive another instant notification of the message on the display unit 132 of the at least one second apparatus 130 via the app running on the at least one second apparatus 130. Subsequently, the at least one lender may use the input unit 131 of the at least one second apparatus 130 to respond.

Alternatively, the at least one borrower may view the profile of the at least one lender on the display unit 122 of the at least one first apparatus 120 and dial a phone number of the at least one lender to initiate another phone call and/or another video call, and the at least one borrower may hit CALL using the input unit 121. The communication unit 124 of the at least one first apparatus 120 may dial the phone number of the at least one lender using the communication unit 134 of the at least one second apparatus 130, such that the at least one lender may receive an incoming call notification on the display unit 132 of the at least one second apparatus 130 via the app running on the at least one second apparatus 130. Subsequently, the at least one lender may use the input unit 131 of the at least one second apparatus 130 to respond.

The at least one lender may use the input unit 131 to accept the predetermined terms of the loan based on whether the at least one borrower agrees to the terms of the lender. Similarly, the at least one borrower may use the input unit 121 to accept the predetermined terms of the loan base don whether the at least lender agrees to the terms of the borrower. As such, a legal contract may be automatically generated in response to an agreement between the at least one borrower and the at least one lender. Additionally, the at least one borrower and/or the at least one lender may receive notification of the legal contract via email, text message, and/or the app. Moreover, the legal contract may include the reason for the loan.

The first apparatus 120 and/or the second apparatus 130 via the app may deduct money from the bank account of the at least one lender to deposit the money into the bank account of the at least one borrower in response to the agreement between the at least one borrower and the at least one lender with respect to the predetermined terms of the loan.

Furthermore, another at least one lender may contribute to the loan using another at least one second apparatus 130. In other words, a plurality of lenders may contribute to the loan to the at least one borrower. Also, a plurality of borrowers may borrow money from the at least one lender.

Additionally, the at least one lender may input on the input unit 131 to set a repayment term on a calendar, the interest rate, a minimum credit score, etc., but is not limited thereto. For example, the at least one lender may input the repayment term is a month, three months, or one year, a 1% interest rate, and a minimum credit score of 650. Moreover, the at least one second apparatus 130 may optionally include repayment reminders. Specifically, the at least one second apparatus 130 may set a predetermined time period to send reminders to the at least one borrower that is stored on the storage unit 135. Subsequently, the processing unit 133 may retrieve the predetermined time period to compare against a current time period on the calendar, such that the processing unit 133 may send a reminder command to the communication unit 134 in response to the comparison of the current time period and the predetermined time period of a due payment, such that the current time period may be equivalent and/or past the predetermined time period. For example, a repayment balance may be due plus interest within a week of the reminder. As such, the communication unit 134 may send the reminder command to the communication unit 124 of the at least one first apparatus 120, such that the communication unit 124 may send the command to the processing unit 123 to display a reminder alert on the display unit 121.

Furthermore, depending on the predetermined terms of the loan, the at least one first apparatus 120 and/or the at least one second apparatus 130 may automatically deduct money from the bank account of the at least one borrower in response to a due payment. Alternatively, the predetermined terms of the loan may require the at least one borrower to voluntarily make payments. In other words, the at least one borrower may choose to delay the time of repayment. As such, the at least one first apparatus 120 and/or the at least one second apparatus 130 may indicate on the calendar a missed payment in response to the at least one borrower failing to make the due payment, including succeeding days that the missed payment is delinquent.

The at least one lender may adjust the interest rate using the input unit 131 of the at least one second apparatus 130. For example, the at least one lender may adjust the interest rate in response to the at least one borrower missing the time of repayment. The at least one second apparatus 130 via the app may prevent the at least one lender from making a significant increase in the interest rate and/or making multiple increases in a short time frame, such as increasing the interest rate more than 1% per increase and/or attempting to make more than one interest rate increase in a week following the missed payment. In other words, the processing unit 133 of the at least one second apparatus 130 may monitor the input unit 131 to prevent the at least one lender from abusing making an increase to the interest rate.

The at least one second apparatus 130 may take action based on the predetermined terms of the loan to enforce the legal contract. First, the at least one second apparatus 130 via the app may automatically increase the interest rate based on the predetermined terms of the loan. As such, the processing unit 133 of the at least one second apparatus 130 may retrieve the predetermined time period to compare against the current time period on the calendar, such that the processing unit 133 may adjust the interest rate in response to the missed payment.

Second, the at least one first apparatus 120 and/or the at least one second apparatus 130 may have a deadline, such as the repayment term to dictate when legal repercussions may be enforced. For example, according to the predetermined terms of the loan, the at least one first apparatus 120 and/or the at least one second apparatus 130 may notify authorities, such as at least one of police, a court, and an arbitrator. Finally, according to the predetermined terms of the loan the at least one first apparatus 120 and/or the at least one second apparatus 130 may enforce repayment by automatic garnishment of money from the bank of the at least one borrower until the loan is repaid. Moreover, the money may be held in escrow until the loan is fully paid and/or immediately transferred from the bank of the at least one borrower to the bank of the at least one lender.

Following a resolution to repayment of the loan and/or involvement by authorities, the at least one first apparatus 120 and/or the at least one second apparatus 130 may query the at least one borrower and/or the at least one lender to provide ratings and/or reviews of each person's experience working with the other. However, the at least one first apparatus 120 and/or the at least one second apparatus 130 via the app may prevent spiteful and/or retaliatory responses in response to a negative rating and/or a negative review from a victorious party.

Referring to FIG. 1, the network 140 may be at least one of the Internet, a cellular network, a universal mobile telecommunications systems (UMTS) network, a Long Term Evolution (LTE) network, a Global System for Mobile Communications (GSM) network, a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. The network 140 can be implemented with any number of hardware and software components, transmission media, and network protocols. FIG. 1 illustrates the network 140 as a single network, but is not limited thereto.

The at least one first apparatus 120 and/or the at least one second apparatus 130 can both can send data to, and receive data from, the storage device 110 over via the Internet or any of the above-mentioned networks. The at least one first apparatus 120 and/or the at least one second apparatus 130 can be directly coupled to the storage device 110. Alternatively, the at least one first apparatus 120 and/or the at least one second apparatus 130 can be connected to the storage device 110 via any other suitable device, communication network, or combination thereof. For example, the at least one first apparatus 120 can be coupled to the storage device 110 via routers, switches, access points, and/or communication networks. In other words, the storage device 110, the at least one first apparatus 120, and the at least one second apparatus 130 may all communicate with each other via the network 140.

Furthermore, any new data input and/or stored on the storage device 110, the storage unit 125 of the at least one first apparatus 120, and/or the storage unit 135 of the at least one second apparatus 130 may be periodically transmitted to each other device and/or apparatus, such that the each other device and/or apparatus may be updated. In other words, the storage device 110, the storage unit 125 of the at least one first apparatus 120, and/or the storage unit 135 of the at least one second apparatus 130 may synchronize to keep the app and data updated.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system having a program running thereon to facilitate and track monetary transactions such as at least a loan between at least one lender and at least one borrower, the system comprising:
a storage device to store data regarding the monetary transactions;
at least one first apparatus, comprising:
a communication unit to receive a list of lenders from the data stored within the storage device,
a display unit to display the list of lenders, and
an input unit to allow at least one borrower to request a loan from at least one of the lenders; and
at least one second apparatus, comprising:
a communication unit to allow the at least one second apparatus to communicate with the at least one first apparatus to receive the input loan request, and
another input unit to allow the at least one lender accept the input loan request.

2. The system of claim 1, further comprising:
a network to allow communication between the storage device, the at least one first apparatus, and the at least one second apparatus.

3. The system of claim 1, wherein the data regarding the monetary transactions is at least one of registration profiles, contacts, files, requests, request acceptances, interest rates, schedules, repayment terms, legal agreements, calendars, payment reminders, payments, programs, application data, and code.

4. The system of claim 1, wherein the at least one first apparatus and the at least one second apparatus requests at least one of an interest rate, a repayment term, a bank account of the at least one borrower, and a bank account of the at least one lender in response to creation of the input loan request.

5. The system of claim 4, wherein the at least one second apparatus deducts money from the bank account of the at least one lender to deposit the money into the bank account of the at least one borrower in response to an agreement between the at least one borrower and the at least one lender based on terms of the input loan request.

6. The system of claim 4, wherein the at least one first apparatus deducts money from the bank account of the at least one borrower in response to a due payment.

7. The system of claim 1, wherein the storage device automatically generates a legal contract in response to acceptance of the input loan request by the at least one lender.

8. The system of claim 4, wherein the storage device notifies the at least one first apparatus and the at least one second apparatus via email that the legal contract has been generated.

9. The system of claim 1, wherein the at least one first apparatus requires the input loan request to include a reason for the loan, such as at least one of starting a business and debt consolidation.

10. The system of claim 7, wherein the at least one second apparatus requires the input loan request to include a contract for a percentage in the business.

11. The system of claim 1, wherein the second apparatus further comprises:
another display unit to display a list of borrowers.

12. The system of claim 1, wherein the input unit includes a filter for the list of lenders, such that the list of lenders is subject to a criteria based on a preference of the at least one borrower.

13. The system of claim 1, wherein the at least one first apparatus selects the list of lenders from at least one of friends, family, and social media acquaintances.

14. The system of claim 1, wherein the at least one second apparatus takes action in response to a missed payment by the at least one borrower.

15. The system of claim 14, wherein the at least one second apparatus takes action by adjusting the interest rate.

16. The system of claim 14, wherein the at least one second apparatus takes action by notifying at least one of police, a court, and an arbitrator.

17. The system of claim 14, wherein the at least one second apparatus takes action by automatic garnishment of money from the at least one first apparatus until the loan is repaid.

18. The system of claim 1, wherein the at least one other second apparatus accepts and funds the input loan request.

19. The system of claim 1, wherein the storage device sends a payment reminder notification to at least one of the at least one first apparatus and the at least one second apparatus in response to a predetermined time period of a due payment.

20. The system of claim 19, wherein the at least one first apparatus reminds the at least one borrower in response to the predetermined time period of the due payment.
